(19) United States
(12) Patent Application Publication
(10) Pub. No.: US 2024/0204632 A1
(43) Pub. Date: Jun. 20, 2024

(54) METHOD FOR MANUFACTURING LAMINATED CORE

(71) Applicant: TOYOTA JIDOSHA KABUSHIKI KAISHA, Toyota-shi, (JP)

(72) Inventors: Kensuke KOMORI, Toyota-shi (JP); Minoru NAKAMURA, Nagoya-shi (JP); Junichi DEGUCHI, Toyota-shi (JP)

(73) Assignee: TOYOTA JIDOSHA KABUSHIKI KAISHA, Toyota-shi, (JP)

(21) Appl. No.: 18/498,683

(22) Filed: Oct. 31, 2023

(30) Foreign Application Priority Data
Dec. 14, 2022 (JP) 2022-199212

(51) Int. Cl. H02K 15/02; H02K 15/12

(52) U.S. Cl. CPC H02K 15/02; H02K 15/12; H02K 2201/09

(57) ABSTRACT

Provided is a method for manufacturing a laminated core capable of reducing the likelihood that the iron loss increases while increasing the space factor of the laminated core. A method for manufacturing a laminated core includes a laminating step of laminating a plurality of thin plates made of a soft magnetic material, an impregnating step of filling a resin into spaces between the plurality of thin plates laminated, and a fixing step of curing the filled resin to fix the plurality of thin plates laminated. In the fixing step, the resin is cured while applying a pressure larger than 0 MPa and equal to or smaller than 1.5 MPa to the plurality of thin plates laminated in a laminating direction of the plurality of thin plates.

### CROSS REFERENCE TO RELATED APPLICATIONS

The present application claims priority from Japanese patent application JP 2022-199212 filed on Dec. 14, 2022, the entire content of which is hereby incorporated by reference into this application.

### BACKGROUND

### Technical Field

The present disclosure relates to a method for manufacturing a laminated core.

### Background Art

Conventionally, as a method for manufacturing a laminated core for motors, laminating a plurality of electromagnetic steel sheets while caulking them is known. Recently, for thinner motors, a method for laminating thin plates made of a soft magnetic material having an amorphous structure or a nano-crystal structure has been used. However, the thin plate made of a soft magnetic material is more brittle and thinner than a conventional electromagnetic steel sheet, and thus it is difficult to laminate thin plates by caulking between adjacent thin plates. In response to this issue, as described in JP 2013-21919 A, for example, a method for fixing laminated thin plates by immersing the laminated thin plates in an epoxy resin and curing the epoxy resin is proposed.

In the above-described method, the resin enters between adjacent thin plates by resin impregnation. Thus, the thickness of the laminated core is equal to the total thickness of the laminated thin plates and the resin that enters between the adjacent thin plates, resulting in a larger thickness of the laminated core as compared to the laminated core manufactured by caulking and laminating electromagnetic steel sheets. A large amount of resin between adjacent thin plates may cause a decrease in the ratio (i.e., a space factor) of the thin plates to the total thickness of the laminated thin plates and the resin that enters between the adjacent thin plates, so it is required to remove the resin from between the adjacent thin plates to some extent by pressurization. However, pressurizing the thin plates made of a soft magnetic material may cause distortion of the material, and the manufactured laminated core may have another problem, such as higher iron losses.

In response to such a technical issue, the present disclosure provides a method for manufacturing a laminated core capable of reducing the likelihood that the iron loss increases while increasing the space factor of the laminated core.

### SUMMARY

A method for manufacturing a laminated core according to the present disclosure includes a laminating step of laminating a plurality of thin plates made of a soft magnetic material, an impregnating step of filling a resin into spaces between the plurality of thin plates laminated, and a fixing step of curing the filled resin to fix the plurality of thin plates laminated. In the fixing step, the resin is cured while applying a pressure larger than 0 MPa and equal to or smaller than 1.5 MPa to the plurality of thin plates laminated in a laminating direction of the plurality of thin plates.

According to the method for manufacturing a laminated core of the present disclosure, in the fixing step, the resin is cured while applying a pressure larger than 0 MPa and equal to or smaller than 1.5 MPa to the plurality of thin plates laminated in a laminating direction of the plurality of thin plates. Therefore, it is possible to remove the resin from between adjacent thin plates, and to prevent the occurrence of distortion of the soft magnetic material. Consequently, the likelihood that the iron loss increases can be reduced while increasing the space factor of the laminated core to be manufactured.

In the method for manufacturing a laminated core according to the present disclosure, in the fixing step, the resin may be cured while applying a pressure larger than 0 MPa and equal to or smaller than 0.5 MPa to the plurality of thin plates laminated in a laminating direction of the plurality of thin plates. In this way, the likelihood that the iron loss of the laminated core to be manufactured increases can be further reduced.

According to the present disclosure, the likelihood that the iron loss increases can be reduced while increasing the space factor of the laminated core to be manufactured.

### BRIEF DESCRIPTION OF THE DRAWINGS

FIG. 1 is a schematic perspective view showing a laminated core;

FIG. 2 is a schematic cross-sectional view for explaining a method for manufacturing a laminated core according to an embodiment;

FIG. 3 is a schematic cross-sectional view for explaining the method for manufacturing the laminated core according to the embodiment;

FIG. 4 is a graph showing the relation between stress and space factor;

FIG. 5 is a graph showing the relation between stress and iron loss; and

FIG. 6 is a graph showing the relation between stress and the rate of iron loss.

### DETAILED DESCRIPTION

An embodiment of the method for manufacturing the laminated core according to the present disclosure will be described below referring to the drawings. In the following explanation, the laminated core structure and the method for manufacturing the laminated core are described in this order.

### [Structure of the Laminated Core]

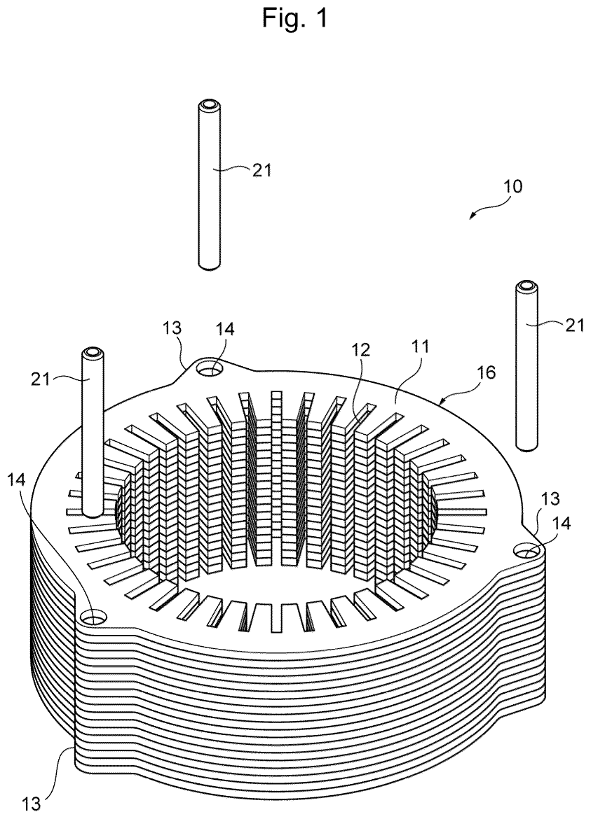

FIG. 1 is a schematic perspective view showing the laminated core. The laminated core 10 is used, for example, in a stator of an in-vehicle motor of a hybrid vehicle or an electric vehicle. As shown in FIG. 1, the laminated core 10 is formed by attaching a collar 21 to a laminated body formed by laminating a plurality of thin plates 16 die-cut in the same shape, and is used as a stator disposed around a rotor (not shown). The laminated core 10 has an annular-shaped yoke portion 11, a plurality of tooth portions 12 projecting radially inward from the inner circumferential surface of the yoke portion 11, and three bulging portions 13 projecting radially outward from the outer circumferential surface of the yoke portion 11.

The yoke portion 11 is formed in an annular shape around the rotating shaft of the rotor, and a space for housing the rotor is secured radially inward of the plurality of tooth portions 12. The plurality of tooth portions 12 are formed at equal intervals in the circumferential direction of the inner circumferential surface of the yoke portion 11. Coils (not shown) are formed by winding conductive wires with an insulating coating around each tooth portion 12.

In each of the three bulging portions 13, a through hole 14 penetrating the thin plates 16 in the laminating direction is formed. The cylindrical collar 21 is inserted into each of the through holes 14. A fastening bolt (not shown) can be inserted into each collar 21. The laminated core 10 configured as described above is fastened to a motor case (not shown) via a fastening bolt that is inserted into the collar 21.

### [Method for Manufacturing the Laminated Core]

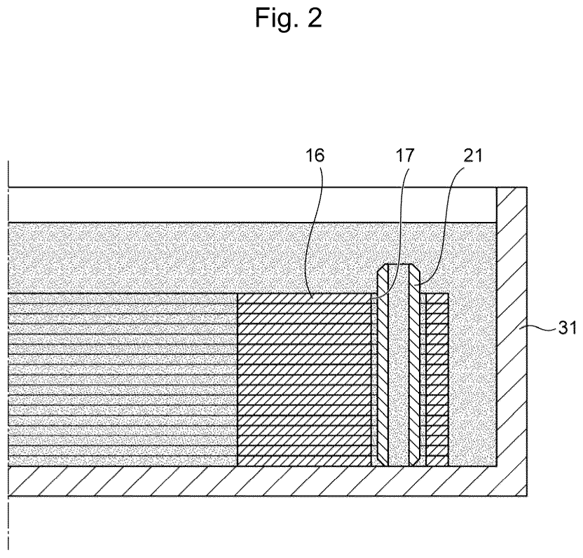

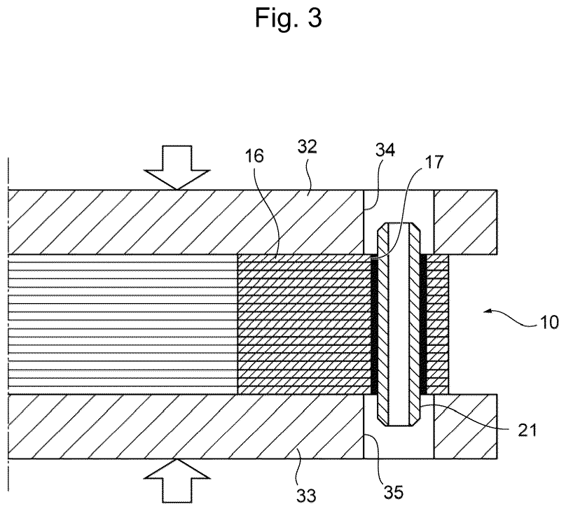

Next, referring to FIG. 2 and FIG. 3, the method for manufacturing the laminated core 10 will be described. The method for manufacturing the laminated core 10 includes a preparing step S1 of preparing the thin plate 16 and the collar 21, a laminating step S2 of laminating a plurality of thin plates 16, an impregnating step S3 of filling a resin into spaces between the plurality of thin plates 16 laminated, and a fixing step S4 of curing the filled resin to fix the plurality of thin plates 16 laminated.

In the preparing step S1, a plurality of thin plates 16 made of a soft magnetic material and a cylindrical collar 21 are prepared. Each thin plate 16 is punched in accordance with the planar configuration of the laminated core 10 (see FIG. 1), and an opening 17 (see FIG. 2) is formed at a position corresponding to the through hole 14 of the laminated core 10. That is, the plurality of thin plates 16 are continuously formed in the laminating direction to form the yoke portion 11, the tooth portions 12, the bulging portions 13, and the openings 17 are continuously formed in the laminating direction to form the through hole 14 (see FIG. 1). As the soft magnetic material, for example, a material having an amorphous structure or a nanocrystalline structure having a thickness of about 0.015 mm to 0.03 mm is used.

Examples of the material having an amorphous structure or a nanocrystalline structure include a material composed of at least one magnetic metal selected from the group consisting of Fe, Co, and Ni, and at least one nonmagnetic metal selected from the group consisting of B. C. P. Al, Si, Ti, V, Cr, Mn, Cu, Y, Zr, Nb, Mo, Hf, Ta, and W. As a material having an amorphous structure or a nanocrystalline structure, a FeCo alloy (FeCo, FeCoV or the like), a FeNi alloy (FeNi, FeNiMo, FeNiCr, FeNiSi or the like), a FeAl alloy or a FeSi alloy (FeAl, FeAlSi, FeAlSiCr, FeAlSiTiRu, FeAlO or the like), a FeTa alloy (FeTa, FeTaC, FeTaN or the like), and a FeZr alloy (FeZrN or the like) can be used. The soft magnetic material is not limited thereto.

The collar 21 is formed in a cylindrical shape by a metallic material such as cast iron. As shown in FIG. 2, the collar 21 functions as a positioning member for the plurality of thin plates 16 when the thin plates 16 are laminated, and functions as a protective member for protecting the thin plates 16 from the fastening bolts when the laminated core 10 is assembled to the motor case. The outer peripheral surface of the collar 21 is formed to have a gap fitting dimension with respect to the opening 17 of the thin plate 16, for example, a gap of 20 μm or less is formed between the opening 17 of the thin plate 16 and the outer peripheral surface of the collar 21. The gap between the opening 17 of the thin plate 16 and the outer peripheral surface of the collar 21 can prevent the thin plate 16 from being damaged when the collar 21 is inserted into the opening 17. The collar 21 has, for example, a length that allows both ends of the collar 21 to protrude from the upper and lower surfaces of the laminated core 10.

In the laminating step S2, for example, while three collars 21 are provided vertically on a block-shaped base (not shown), the thin plates 16 are laminated such that the collars 21 are inserted through the three openings 17 formed in the thin plates 16. Here, with the openings 17 of the thin plates 16 located above the collars 21, the thin plates 16 are lowered toward the base, being guided by the collars 21, to be laminated. Since the plurality of thin plates 16 are positioned with respect to the three collars 21, it is possible to suppress the positional deviation in the rotational direction and the axial direction of the thin plates 16. Further, the thin plates 16 can be laminated smoothly because there is a slight gap between the opening 17 of the thin plate 16 and the outer peripheral surface of the collar 21.

In the impregnating step S3, a resin is filled into the spaces between the plurality of thin plates 16 laminated. Here, as shown in FIG. 2, an uncured resin (more specifically, an uncured thermosetting resin) is stored in a liquid tank 31, and the plurality of laminated thin plates 16 and the collar 21 are immersed in a liquid uncured resin in the liquid tank 31. By immersing, the uncured resin enters between the plurality of laminated thin plates 16 and also enters between the openings 17 of the plurality of thin plates 16 and the outer peripheral surface of the collar 21. As a result, the plurality of laminated thin plates 16 are temporarily fixed by resin. Further, the plurality of thin plates 16 and the collar 21 are temporarily fixed by resin. Therefore, even if the thin plates 16 and the collar 21 are pulled up from the liquid tank 31, the collar 21 will not come off from the openings 17 of the plurality of thin plates 16.

In the present embodiment, a thermosetting resin is used as the resin. Examples of the thermosetting resin include epoxy resin, phenolic resin, urea resin, and melamine resin. As the resin, a thermoplastic resin may be used. Examples of the thermoplastic resin include polyethylene resin, polyamide resin, polystyrene resin, and acrylic resin.

In the fixing step S4, the uncured resin filled into the plurality of thin plates 16 and the collars 21 is cured to fix the plurality of laminated thin plates 16 and to integrate the plurality of thin plates 16 and the collars 21 by the resin. Here, as shown in FIG. 3, the thin plates 16 and the collar 21 are pulled up from the liquid tank 31, and the plurality of resin-impregnated thin plates 16 are arranged between a pair of upper and lower pressurizing jigs 32 and 33 as prepared. The pressurizing jigs 32 and 33 are provided with relief holes 34 and 35 at positions corresponding to the collar 21, so that the collar 21 and the pressurizing jigs 32 and 33 are prevented from interfering with each other. Then, as shown by the arrows in FIG. 3, using the pressurizing jigs 32 and 33, the uncured resin is cured while the plurality of resin-impregnated thin plates 16 are pressurized in the laminating direction of the thin plates 16 (in this case, the up-down direction).

When the pressure is applied, the uncured resin between the adjacent thin plates 16 is removed, and thus the thickness of the laminated body made of the plurality of thin plates 16 is reduced. As the thickness of the laminated body is reduced, the protrusion of the collar 21 from the laminated body is relatively increased. In the present embodiment, at the stage of the impregnating step S3 described above, the upper end of the collar 21 already protrudes from the thin plate 16 at the top end in the laminating direction (see FIG. 2), but the lower end of the collar 21 protrudes from the thin plate 16 at the bottom end in the laminating direction when the plurality of thin plates 16 are pressurized. At the stage of the impregnating step S3 described above, both ends of the collar 21 may be protruded from the thin plates 16 at both top and bottom ends in the laminating direction.

Then, the uncured resin between the plurality of thin plates 16 and the uncured resin between the openings 17 of the plurality of thin plates 16 and the outer peripheral surface of the collar 21 are heated (for example, placed in a heating furnace and heated) and cured while the plurality of thin plates 16 are pressurized by the pressurizing jigs 32 and 33. As a result, the adjacent thin plates 16 can be fixed to each other with the resin while both ends of the collar 21 protrude from the thin plates 16 at both top and bottom ends in the laminating direction, and the plurality of thin plates 16 and the collar 21 can be integrated by the resin. The pressurizing surfaces of the pressurizing jigs 32 and 33 (that is, the surfaces in contact with the thin plates 16) are surface-coated with a release agent, and a gap is formed between the inner peripheral surface of the relief holes 34 and 35 and the outer peripheral surface of the collar 21, so that adhesion of the thin plates 16 and the collar 21 to the pressurizing jigs 32 and 33 is suppressed after the curing of the uncured resin.

In the present embodiment, a thermosetting resin is used as the resin, but a thermoplastic resin may be used. In this case, the thermoplastic resin is softened, and after the resin is filled into the spaces between the plurality of thin plates 16 and the spaces between the openings 17 of the plurality of thin plates 16 and the outer peripheral surface of the collar 21, the thermoplastic resin may be cured by cooling while pressurizing the plurality of thin plates 16 in the laminating direction.

The laminated core 10 is manufactured in this manner. After the laminated core 10 is manufactured, coils may be formed by winding conductive wires with an insulating coating around each tooth portion 12 of the laminated core 10.

As described above, in order to increase the space factor of the laminated core 10 (i.e., the ratio of the thin plates 16 to the total thickness of the laminated thin plates 16 and the resin that enters between the adjacent thin plates 16), it is required to remove the resin from between the adjacent thin plates 16 to some extent by pressurization. However, pressurizing the thin plates 16 may cause distortion in the thin plates 16 made of a soft magnetic material, resulting in higher iron loss of the laminated core 10. That is, it is not possible to both increase the space factor of the laminated core 10 and reduce the likelihood that the iron loss increases. Therefore, the inventors of the present application have conducted intensive studies and found that when a pressure larger than 0 MPa and equal to or smaller than 1.5 MPa is applied to the plurality of laminated thin plates 16 in the laminating direction of the thin plates 16, it is possible to both increase the space factor of the laminated core 10 and reduce the likelihood that the iron loss increases.

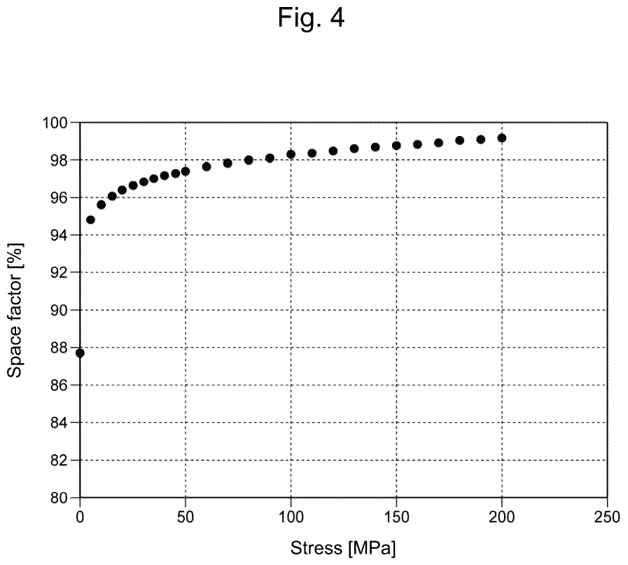

Specifically, the inventors of the present application first examined the relation between stress and the space factor with respect to the effect of pressurization (in other words, stress application) on the space factor. Table 1 is a result obtained by the inventors of the present application conducting an experiment and the like using the samples of the thin plates 16 laminated according to the above-described manufacturing method. FIG. 4 is a graph of the relation between stress and the space factor prepared based on the result shown in Table 1. Here, stress indicates the force per unit area of the thin plate 16 at the time of pressurization.

As can be seen from Table 1 and FIG. 4, the space factor increases as stress increases, but becomes gradually saturated. Then, if it is desired to secure a space factor of more than 95%, a stress of approximately 10 MPa is required.

TABLE 1

| Stress (MPa) | Space factor (%) | Iron loss W10/400 (W/kg) |
|---|---|---|
| 0 | 87.75994 | 2.346 |
| 0.5 | 91.71917 | 3.627 |
| 1 | 92.5 | 4.063 |
| 1.5 | 92.95983 | 4.831 |
| 2 | 93.28747 | — |
| 5 | 94.79858 | — |
| 10 | 95.58526 | — |
| 15 | 96.03455 | — |
| 20 | 96.36347 | 6.029378 |
| 25 | 96.60757 | — |
| 30 | 96.82012 | — |
| 35 | 96.98974 | — |
| 40 | 97.14346 | — |
| 45 | 97.2756 | — |
| 50 | 97.40811 | 6.547677 |
| 60 | 97.61309 | — |
| 70 | 97.79665 | — |
| 80 | 97.95294 | — |
| 90 | 98.09851 | — |
| 100 | 98.22765 | — |
| 110 | 98.34021 | — |
| 120 | 98.44739 | — |
| 130 | 98.56047 | — |
| 140 | 98.65678 | — |
| 150 | 98.74193 | — |
| 160 | 98.82722 | — |
| 170 | 98.91265 | — |
| 180 | 98.99824 | — |
| 190 | 99.06681 | — |
| 200 | 99.12975 | — |

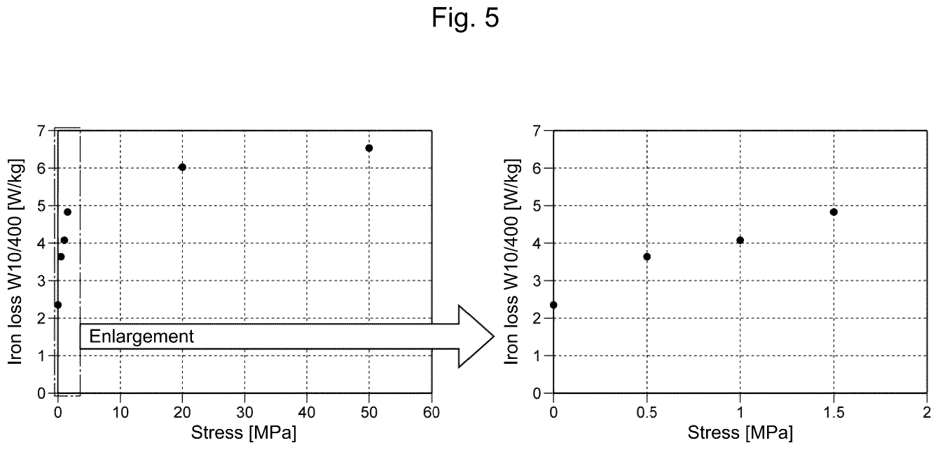

Next, the inventors of the present application examined the relation between stress and iron loss with respect to the effect of pressurization (in other words, stress application) on the iron loss, and the results are shown in Table 1 and FIG. 5. In FIG. 5, the horizontal axis represents stress, and the vertical axis represents the absolute value of iron loss W10/400. W10/400 means iron loss at frequency 400 Hz and magnetic flux density 1.0 T.

As shown in FIG. 5, when resin-curing is performed under pressure, it can be seen that due to distortion in the material, the iron loss increases as compared with the case where the pressure is not applied. Then, as stress increases, the iron loss becomes saturated, but increases linearly until the stress reaches several MPa. Although the distortion of the material is generated by pressurization also in the case of the conventional electromagnetic steel sheet, the generated distortion can be removed in the subsequent high-temperature heat treatment (approximately 700° C. or higher), so that the likelihood that the iron loss increases can be reduced. However, such high-temperature heat treatment is not applicable to resin.

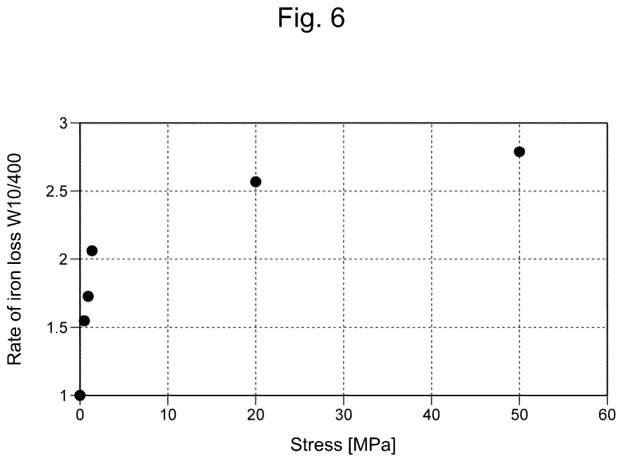

Next, the inventors of the present application calculated the rates of the absolute value of iron loss W10/400 shown in the vertical axis of FIG. 5 when the iron loss at stress 0 (zero) MPa is set to 1, and created the graph shown in FIG. 6 based on the calculated results. That is, in FIG. 6, the horizontal axis represents stress, and the vertical axis represents the rate of iron loss W10/400.

As shown in Table 1 and FIG. 6, under a pressure of 1.5 MPa, the iron loss W10/400 is 4.831 (unit: W/kg), which is equal to or more than twice as high as that at stress 0 (2.346 W/kg). Since the iron loss W10/400 of the conventional electromagnetic steel sheet (for example, thickness 0.25 mm) is 12 to 14 W/kg, it can be seen that the iron loss W10/400 under a pressure of 1.5 MPa can be reduced by about 60% (in other words, it can be improved by 60% or more) as compared with the conventional electromagnetic steel sheet. In addition, it can be seen that when the resin is cured while applying a pressure of 1.5 MPa to the laminated thin plates 16, the laminated core 10 having a space factor of about 93% can be obtained.

Therefore, in the fixing step S4 of the present embodiment, using the pressurizing jigs 32 and 33, a pressure larger than 0 MPa and equal to or smaller than 1.5 MPa is applied to the plurality of laminated thin plates 16 in the laminating direction. In this way, since it is possible to remove the resin from between the adjacent thin plates 16, it is possible to reduce the thickness of the laminated core 10 to be manufactured and to prevent the occurrence of distortion of the soft magnetic material, it is possible to suppress the loss of excellent low iron loss properties of the soft magnetic material. Consequently, the likelihood that the iron loss increases can be reduced while increasing the space factor of the laminated core 10 to be manufactured.

In the fixing step S4, the resin may be cured while applying a pressure larger than 0 MPa and equal to or smaller than 0.5 MPa to the plurality of laminated thin plates 16 in the laminating direction. In this way, the likelihood that the iron loss of the laminated core 10 increases can be further reduced.

Although the embodiment of the present disclosure has been described in detail above, the present disclosure is not limited to the above-described embodiment, and various design changes can be made without departing from the spirit of the present disclosure described in the claims.

What is claimed is:

1. A method for manufacturing a laminated core comprising:
a laminating step of laminating a plurality of thin plates made of a soft magnetic material;
an impregnating step of filling a resin into spaces between the plurality of thin plates laminated; and
a fixing step of curing the filled resin to fix the plurality of thin plates laminated,
wherein in the fixing step, the resin is cured while applying a pressure larger than 0 MPa and equal to or smaller than 1.5 MPa to the plurality of thin plates laminated in a laminating direction of the plurality of thin plates.

2. The method for manufacturing a laminated core according to claim 1, wherein in the fixing step, the resin is cured while applying a pressure larger than 0 MPa and equal to or smaller than 0.5 MPa to the plurality of thin plates laminated in a laminating direction of the plurality of thin plates.
